(19) United States
(12) Patent Application Publication
(10) Pub. No.: US 2025/0222703 A1
(43) Pub. Date: Jul. 10, 2025

(54) INKJET IMAGE FORMING APPARATUS

(71) Applicant: KYOCERA Document Solutions Inc., Osaka (JP)

(72) Inventor: Nobuhiro MAEZAWA, Osaka-shi (JP)

(73) Assignee: KYOCERA Document Solutions Inc., Osaka (JP)

(21) Appl. No.: 19/008,223

(22) Filed: Jan. 2, 2025

(30) Foreign Application Priority Data
Jan. 10, 2024 (JP) 2024-001822

(51) Int. Cl. B41J 11/00; B41J 2/21; C09D 11/037; C09D 11/102; C09D 11/322; C09D 11/54

(52) U.S. Cl. CPC B41J 11/0022; B41J 2/2103; B41J 2/2117; C09D 11/037; C09D 11/102; C09D 11/322; C09D 11/54

(57) ABSTRACT

An inkjet image forming apparatus includes an image forming part, a precoating unit, a pre-drying part, and a control part. The precoating unit is arranged on an upstream side of the image forming part. The pre-drying part is arranged on a downstream side of the precoating unit, and pre-dries the precoating liquid ejected on the printing base material before the inks are ejected in the image forming part. The control part controls the pre-drying part so that W1<W2, where W1 (g/m²) is an amount of the pre-coating liquid ejected to the printing base material conveyed to the image forming part when a print job for ejecting the white ink is performed, and W2 (g/m²) is an amount of the pre-coating liquid ejected to the printing base material conveyed to the image forming part when a print job for not ejecting the white ink is performed.

### INCORPORATION BY REFERENCE

This application is based on and claims the benefit of priority from Japanese patent application No. 2024-001822 Jan. 10, 2024, which is incorporated by reference in its entirety.

### BACKGROUND

The present disclosure relates to an inkjet image forming apparatus which forms an image on a printing base material by an inkjet method.

In the inkjet type image forming apparatus, in order to enhance adhesion of ink to the printing base material, a precoating treatment for applying a precoating liquid to the printing base material may be performed.

For example, a pre-treatment liquid (corresponding to the precoating liquid) of an amount determined based on a type of the ink and an amount per unit area of the ink ejected onto a recording medium (corresponding to the printing base material) is applied.

In general, white ink is known to have lower adhesion to the printing base material than the other color inks. This is because it is necessary to increase a particle size of a pigment in order to increase an opacity ratio of the white color, and in this case, the pigment cannot be completely coated with a binder resin, resulting in poor adhesion to the printing base material. This tendency becomes higher in the case of the printing base material having a smooth surface such as a plastic film. For this reason, there is a case where a print job for ejecting the white ink is performed by increasing an ejection amount of the white ink over an ejection amount of the other color inks.

However, when an ejection amount of the ink is increased, the ink (solvent such as water contained in the ink) may not be sufficiently dried in a drying step after the ink ejection. If the ink is not sufficiently dried after the drying step, when the printing base materials are stacked in the upper-and-lower direction, a problem occurs in which the ink of the lower printing base material moves to the rear surface of the upper printing base material. When the precoating treatment is performed, the solvent contained in the applied precoating liquid is also contained, so that the dryness is further reduced. Such a dryness is not considered in the above image forming apparatus.

### SUMMARY

An inkjet image forming apparatus according to the present disclosure includes an image forming part, a precoating unit, a pre-drying part, and a control part. The image forming part ejects inks of a plurality of colors containing white on a printing base material conveyed in a predetermined conveyance direction, to form an image. The precoating unit is arranged on an upstream side of the image forming part in the conveyance direction, and ejects a precoating liquid on the printing base material. The pre-drying part is arranged on a downstream side of the precoating unit in the conveyance direction, and pre-dries the precoating liquid ejected on the printing base material before the inks are ejected in the image forming part. The control part controls the pre-drying part to adjust a degree of dryness of the precoating liquid ejected on the printing base material. The control part controls the pre-drying part so that W1<W2, where W1 (g/m²) is an amount of the pre-coating liquid ejected to the printing base material conveyed to the image forming part when a print job for ejecting the white ink is performed, and W2 (g/m²) is an amount of the pre-coating liquid ejected to the printing base material conveyed to the image forming part when a print job for not ejecting the white ink is performed.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inkjet image forming apparatus according to one embodiment of the present disclosure.

FIG. 2 is a plan view showing a head unit, in the inkjet image forming apparatus according to the embodiment of the present disclosure.

FIG. 3A is a photograph showing a result (magenta image) of a peeling test, in the inkjet image forming apparatus according to the embodiment of the present disclosure.

FIG. 3B is a photograph showing a result (white image, a precoating treatment is performed) of the peeling test, in the inkjet image forming apparatus according to the embodiment of the present disclosure.

FIG. 3C is a photograph showing a result (white image, the precoating treatment is not performed) of the peeling test, in the inkjet image forming apparatus according to the embodiment of the present disclosure.

FIG. 4 is a table showing a result for evaluation of adhesion, opacifying property, and white ink dryness, in the inkjet image forming apparatus according to the embodiment of the present disclosure.

### DETAILED DESCRIPTION

Hereinafter, an inkjet image forming apparatus according to one embodiment of the present disclosure will be described with reference to the drawings.

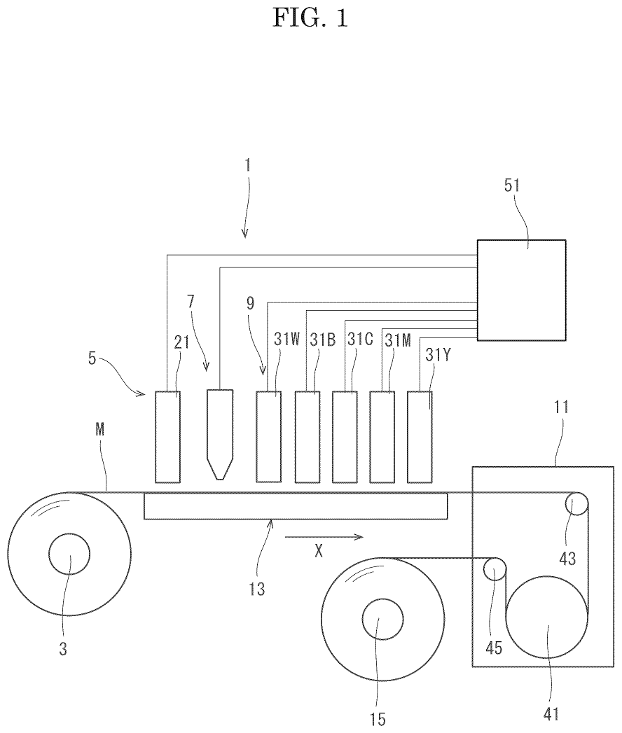

With reference to FIG. 1, the entire structure of the inkjet image forming apparatus 1 will be described. FIG. 1 is a front view schematically showing an internal structure of the inkjet image forming apparatus 1.

The inkjet image forming apparatus 1 includes a supply roller 3 around which a long printing base material M is wound, a precoating unit 5 which applies a precoating treatment for applying a precoating liquid to the printing base material M, a pre-drying part 7 which pre-dries the precoating liquid applied to the printing base material M, an image forming part 9 which forms an image on the printing base material M by an inkjet method, a main-drying part 11 which dries the image formed on the printing base material M, a conveying plate 13 arranged between the supply roller 3 and the main-drying part 11, and a winding roller 15 which winds up the printing base material M.

First, the supply roller 3 will be described. The long printing base material M is wound around the supply roller 3 and attached to. When the supply roller 3 is rotated, the printing base material M is fed out in the conveyance direction X.

Next, the precoating unit 5 will be described. The precoating unit 5 is arranged on the downstream side of the supply roller 3 in the conveyance direction X, and performs a precoating treatment for applying a predetermined amount of a precoating liquid to the printing base material M fed from the supply roller 3. The precoating unit 5 includes a precoating head unit 21 which ejects the precoating liquid. The precoating head unit 21 is electrically connected to a control part 51.

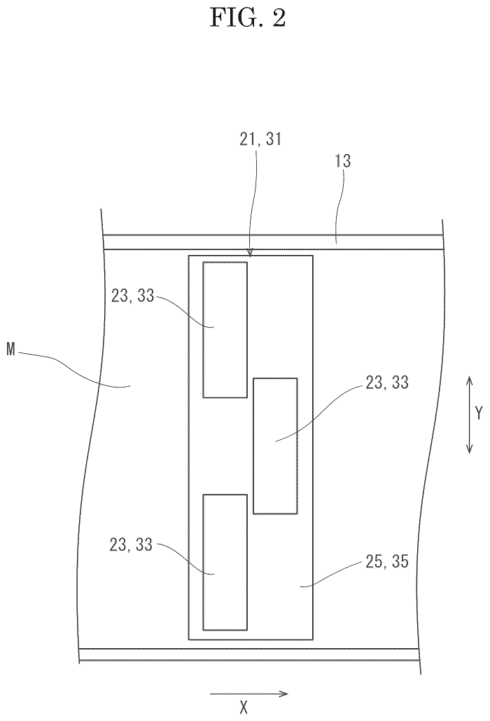

With reference to FIG. 2, the precoating head unit 21 will be described. FIG. 2 is a plan view showing the precoating head unit 21. The precoating head unit 21 is provided with three print heads 23 and a plate 25 for supporting the three print heads 23. The three print heads 23 are disposed in a staggered pattern along the width direction Y (intersecting the conveyance direction X) so as to have a length approximately equal to a width of the printing base material M (line head system), and are supported by the plate 25. The precoating liquid is supplied from a precoating liquid supply source to the three print heads 23.

The print head 23 includes a large number of nozzles and piezoelectric element provided in each nozzle. The ejection port of the nozzle is opened on the lower surface of the print head 23. The piezoelectric element is deformed by being applied with a voltage, and the precoating liquid in the nozzle is ejected downward through the ejection port.

The components of the precoating liquid are, for example, 10% polyester resin (Trade name, PESRESIN A-640, manufactured by TAKAMATSU OIL & HAT CO., LTD.), 0.04% surfactant (Trade name, Surfynol 440, manufactured by Nisshin Chemical co., ltd.), 25% propylene glycol, and 64.96% water.

Next, the pre-drying part 7 will be described with reference to FIG. 1. The pre-drying part 7 is arranged on the downstream side of the precoating unit 5 in the conveyance direction X, and evaporates a solvent such as water contained in the precoating liquid ejected to the printing base material M to pre-dry the ejected precoating liquid to an extent of half-drying. The pre-drying part 7 includes a heater for heating air and a fan for blowing the air heated by the heater toward the printing base material M. The pre-drying part 7 is electrically connected to the control part 51.

Next, the image forming part 9 will be described with reference to FIG. 1. The image forming part 9 forms an image on the printing base material M by an inkjet method. The image forming part 9 includes five image forming head units 31W, 31B, 31C, 31M, and 31Y (collectively referred to as the image forming head unit 31) corresponding to the inks of five colors (white, black, cyan, magenta, and yellow). The five image forming head units 31W, 31B, 31C, 31M, and 31Y are arranged in order along the conveyance direction X. The five image forming head units 31 are electrically connected to the control part 51.

The image forming head unit 31 has the same configuration as the precoating head unit 21 of the precoating unit 5 shown in FIG. 2, and includes the three print heads 33 and the plate 35 for supporting the three print heads 33. The white, black, cyan, magenta, and yellow inks are supplied to the three print heads 33 of the five image forming head units 31W, 31B, 31C, 31M, and 31Y, respectively.

The print head 33 includes a large number of nozzles and piezoelectric elements provided in each nozzle. The ejection port of the nozzle is opened on the lower surface of f the print head 33. The piezoelectric element is deformed by being applied with a voltage, and the ink in the nozzle is ejected downward from the ejection port.

The pigment of the white ink is titanium oxide and the binder resin is polyurethane resin. A viscosity ρw (mPa·s) of the white ink at 25° C. is smaller than a viscosity ρc (mPa·s) of the other color inks at 25° C. Furthermore, an average particle diameter Dw (nm) of the pigment of the white ink is larger than an average particle diameter Dc (nm) of the pigment of the other color inks.

Next, the main-drying part 11 will be described with reference to FIG. 1. The main-drying part 11 is arranged on the downstream side of the image forming part 9 in the conveyance direction X, and dries the image formed on the printing base material M by the image forming part 9. The main-drying part 11 includes a heat drum 41, and upstream-side and downstream-side tension rollers 43, 45 arranged on the upstream side and the downstream side of the heat drum 41. The printing base material M passing through the image forming part 9 is wound around the heat drum 41 between the upstream-side and downstream-side tension rollers 43 and 45. The heat drum 41 is heated to dry the printing base material M conveyed along the surface.

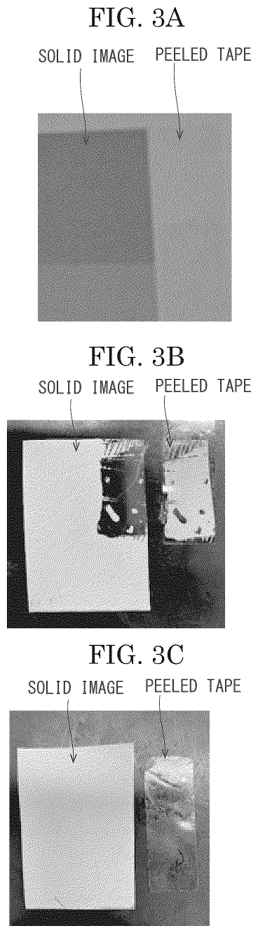

Next, the conveying plate 13 will be described with reference to FIG. 1. The conveying plate 13 is arranged below the precoating unit 5, the pre-drying part 7, and the image forming part 9 (the five head units 31). The upper surface of the conveying plate 13 is formed flat. As shown in FIG. 3, a width of the conveying plate 13 is larger than a width of the printing base material M and all the head units 31. A heat source (not shown) is provided below the conveying plate 13 to heat the conveying plate 13 to a predetermined temperature. The conveying plate 13 is made of metal, for example.

Next, the winding roller 15 will be described. The end of the printing base material M is fixed to the winding roller 15. The winding roller 15 is connected to a motor (not shown) and is rotated. By rotating the winding roller 15 in a predetermined direction at a predetermined rotational speed by the motor, the printing base material M is fed out from the supply roller 3.

The fed printing base material M passes under the precoating unit 5, the pre-drying part 7, and the image forming part 9 above the conveying plate 13, is wound on the heat drum 41 in the main-drying part 11, and is then wound around the winding roller 15.

Next, the control part 51 will be described with reference to FIG. 1. To the control part 51, data of the image to be printed is input. The control part 51 determines whether a printing job to be performed is a printing job in which the white ink is ejected or a printing job in which the white ink is not ejected, based on the input data.

The control part 51 controls a temperature and an air volume of the hot air blown out in the pre-drying part 7 to adjust a degree of drying (degree of evaporation of the solvent such as water) of the precoating liquid ejected to the printing base material M, based on the printing job. More specifically, in the case of the print job in which the white ink is not ejected, the degree of drying is set to a reference level. The reference level is a level at which the solvent in the precoating liquid evaporates to such an extent that a precoating effect is sufficiently exhibited, and the ejected precoating liquid is dried to an extent of half-drying. On the other hand, in the case of the print job in which the white ink is ejected, the degree of drying is set to a high level higher than the reference level (easy to dry). However, even at the high level, the ejected precoating liquid is not completely dried but dried to a degree slightly drier than the reference level of half-drying such that the precoating effect can be exhibited.

Further, the control part 51 is also electrically connected to the head unit 21 of the precoating unit 5 to control the head unit 21 so as to eject a fixed amount of the precoating liquid. Further, the control part 51 is also electrically connected to the five head units 31 of the image forming part 9 to control the ejection of the ink from each head unit 31 based on the input image data.

An image forming operation on a non-absorbent base material (plastic film) in the inkjet image forming apparatus 1 having the above configuration will be described. At the start of the image forming operation, the control part 51 determines whether the print job is the print job in which the white ink is ejected or the print job in which the white ink is not ejected, based on the input image data. First, the winding roller 15 is driven by the motor to be rotated, and the printing base material M is fed out from the supply roller 3. The fed printing base material M is sequentially conveyed to the precoating unit 5, the pre-drying part 7, and the image forming part 9 along the upper surface of the conveying plate 13.

The precoating unit 5 ejects the fixed amount of the precoating liquid to the printing base material M. Thereafter, the printing base material M on which the precoating liquid is ejected is conveyed to the pre-drying part 7. When the print job is the print job in which the white ink is not ejected, the pre-drying part 7 dries the pre-coating liquid ejected to the printing base material M at the reference level. On the other hand, when the print job is the print job in which the white ink is ejected, the pre-drying part 7 dries the precoating liquid ejected to the printing base material M at the high level. The printing base material M in which the precoating liquid is pre-dried in this manner is conveyed to the image forming part 9.

In the image forming part 9, the ink of the predetermined color is ejected from the corresponding head unit 31 based on the image data, and an image is formed on the printing base material M. The printing base material M on which the image is formed is conveyed to the main-drying part 11. In the main-drying part 11, the ink is completely dried. Thereafter, the printing base material M is wound by the winding roller 15.

As described above, according to the present disclosure, in the case of the print job in which the white ink is ejected, the degree of drying of the precoating liquid by the pre-drying part 7 (the degree of evaporation of the solvent) is set higher than in the case of the print job in which the white ink is not ejected. As a result, an amount W1 (g/m²) of the precoating liquid ejected to the printing base material M conveyed to the image forming part 9 in the case of the print job in which the white ink is ejected is smaller than an amount W2 (g/m²) of the precoating liquid ejected to the printing base material M conveyed to the image forming part 9 in the case of the print job in which the white ink is not ejected (W1<W2).

In the case of the print job in which the white ink is ejected, an amount of the ink ejected by the image forming part 9 increases by an amount of white ink. In addition, the white ink has a larger ejection amount than the other color inks in order to enhance the opacifying property. For this reason, a total amount of the ink ejected to the printing base material M, that is, an amount of the solvent contained in the printing base material M becomes larger than in the case of the print job in which the white ink is not ejected. Then, there is a possibility that the solvent is not completely dried in the main-drying part 11.

Therefore, in the print job in which the white ink is ejected, the degree of drying of the precoating liquid by the pre-drying part 7 is set higher than in the case of the print job in which the white ink is not ejected. Therefore, an amount of the solvent contained in the precoating liquid ejected to the printing base material M can be reduced to such a degree that the effect of enhancing the adhesion of the ink by the precoating treatment can be maintained and that the ink can be completely dried by the main-drying part 11. Further, the pre-drying step reduces the amount of the solvent in the precoating liquid and increases the viscosity, so that the precoating effect can be enhanced.

The pigment of the white ink is titanium oxide, and the binder resin is polyurethane resin. Titanium oxide is known as a pigment having a good opacifying property. Since the polyurethane resin has a good compatibility with the printing base material, the adhesion between the white ink and the printing base material M can be enhanced. The white ink generally includes water and a high boiling point material having a boiling point higher than that of water. Water is easier to dry than the high boiling material. Therefore, an amount of the high boiling point material contained is decreased and its water content is increased by the same amount. As a result, a viscosity of the white ink is apparently low.

In order to improve the opacifying property of the white ink, it is preferable that a size (average particle diameter) of the pigment of the white ink is large. In this embodiment, a viscosity of the pigment of the white ink is reduced and the average particle diameter is increased, so that the opacifying property can be enhanced.

In order to reduce the amount of the precoating liquid ejected to the printing base material M conveyed to the image forming part 9 in the case of the print job in which the white ink is ejected, as compared with the case of the print job in which the white ink is not ejected, it is conceivable to reduce the amount of the precoating liquid applied by the precoating unit 5 in the case of the print job in which white ink is ejected, as compared with the case of a print job in which white ink is not ejected. In an inkjet type image forming apparatus, there is a viscosity range of the ink suitable for the print head. Therefore, in the precoating unit 5, a material necessary for fixing the ink is diluted with a solvent such as water to obtain an appropriate viscosity. Therefore, if the amount of the precoating liquid to be ejected is reduced, an amount of the material required for the fixing is lower, and a sufficient precoating result cannot be obtained.

Next, a test for evaluation of the adhesion of the ink in the inkjet image forming apparatus 1 of the present embodiment will be described.

As Comparative Example 1, the printing base material M on which a cyan solid image is printed at 600 dpi without applying the precoating treatment is prepared. As Comparative Example 2, the printing base material M on which a white solid image is printed at 600 dpi without applying the precoating treatment is prepared. On the other hand, as Present Example, the printing base material M in which the precoating treatment is applied, pre-dried, and then printed with a white solid image at 600 dpi is prepared. The printing base material M is an OPP film, a width of the printing base material M is 210 mm, and a conveying speed of the printing base material M is 3 m/min. The components of the precoating liquid in Present Example are 10% polyester resin (Product name: Pesresin A-640, manufactured by Takamatsu Resin Co., Ltd.), 0.04% surfactant (Product name Surfinol 440, manufactured by Nisshin Chemical Industry Co., Ltd.), 25% propylene glycol, 64.96% water, and the applied amount of the precoating liquid is 3 g/m². A temperature of the hot air in the pre-drying part 7 is 80° C., a wind velocity is 10 m/s, and the amount of the pre-coating liquid when the printing base material M is conveyed to the image forming part 9 is 2 g/m².

The adhesion is evaluated by a peeling test (cross cut is not formed) based on JISK5600. The tape (Product name: CT18, manufactured by NICHIBAN) is firmly rubbed onto the image with a fingertip, and within 5 minutes, the tape is peeled off, or the edge of the tape is grasped at an angle about 60 degrees and firmly pulled away within 0.5 to 1.0 seconds.

Photographs of the images of Comparative Examples 1, 2 and Present Example after the tape is peeled are shown in FIG. 3A, FIG. 3B, and FIG. 3C. FIG. 3A shows Comparative Example 1, FIG. 3B shows Comparative Example 2, and FIG. 3C shows Present Example. In each photograph, the left side shows the printing base material with the tape peeled off, and the right side shows the peeled tape.

As shown in FIG. 3A, no image peeling is observed for the cyan solid image, however, image peeling is observed for the white solid image as shown in FIG. 3B. On the other hand, as shown in FIG. 3C, no image peeling is observed in Present Example. From these results, it is confirmed that the precoating treatment and the pre-drying step are necessary, especially when the white image is printed.

Next, in the inkjet image forming apparatus 1 of the present embodiment, a test for evaluation of adhesion, opacifying property, and white ink dryness in the image containing the white color will be described.

In Present Examples 1 to 6, the printing base material M is prepared in which the precoating treatment is applied, pre-dried such that the amount of the precoating liquid at the time when the printing base material is conveyed to the image forming part (referred to as the residual amount of the precoating liquid) is smaller than the residual amount of the precoating liquid of the image not containing the white color, and an image containing the white color is printed at 600 dpi. Present Examples 1 to 4 show that a viscosity of the white ink is lower than a viscosity of the other color inks ink, and an average particle size of the white ink is larger than an average particle size of the other color inks. Present Example 5 shows that a viscosity of the white ink is equal to a viscosity of the other color inks. Present Example 6 shows that an average particle diameter of the white ink is equal to an average particle diameter of the other color inks. On the other hand, in Comparative Example 1, the printing base material M is prepared in which the precoating treatment is applied, pre-dried such that the residual amount of the precoating liquid is equal to the residual amount of the precoating liquid of the image not containing the white color, and an image containing the white color is printed at 600 dpi under the same conditions of viscosity and average particle diameter as those in Present Example 1. The printing base material M is an OPP film, a conveying speed is 25 m/min, and an amount of the ejected precoating liquid is 3 g/m².

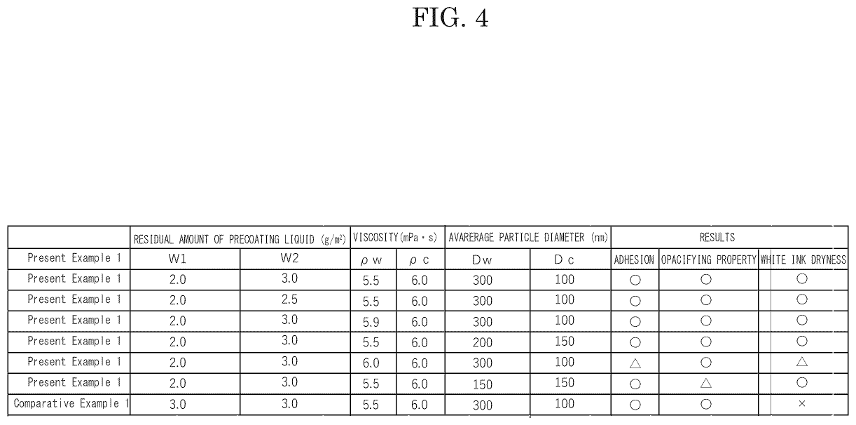

FIG. 4 shows the results of evaluation of adhesion, opacifying property, and white ink dryness of Present Examples 1 to 6 and Comparative Example.

The adhesion is evaluated by an image density of the peeled tape in the peeling test described above. In detail, the unused tape and the peeled tape are pasted on a copy paper (Product name C2, manufactured by Fujifilm Business Innovation Co., Ltd.), and the image density is measured by an image densitometer (Product name FD-5, manufactured by Konica Minolta). When a difference in the image density between the unused tape and the peeled tape is less than 0.05, it is shown by o, when the difference is less than 0.15, it is shown by A, and when the difference is 0.15 or more, it is shown by x.

The opacifying property is evaluated by the following methods. The image formed on the printing base material is placed on a black color area of an opacity ratio test paper (manufactured by TP Giken Co., Ltd.), and the density of the black color is measured using a spectral colorimeter (Product name CM-25cG, manufactured by Konica Minolta). When the image density is less than 0.2, it is shown by o, when the image density is less than 0.3, it is shown by A, and when the image density is 0.3 or more, it is shown by X.

The white ink dryness property is evaluated by the following method. An OPP film is placed on the image of the printing base material 3 seconds after the main drying, and when the ink offset is observed, it is shown by o, when the ink offset is observed after 3 seconds, it is shown by Δ, and when the ink offset is observed after 5 seconds, it is shown by X.

As shown in Present Examples 1 to 4, when a viscosity of the white ink is reduced and an average particle diameter is increased, the precoating treatment and the pre-drying provide good results in the adhesion, opacifying property, and white ink dryness by performing the precoating treatment and pre-drying.

On the other hand, as shown in Present Example 5, when a viscosity of the white ink is increased, sufficient adhesion is not obtained. This is because a viscosity of the ink is high and the ink could not be sufficiently dried. Further, as shown in Present Example 6, when a particle size of the white ink is reduced, sufficient opacifying property is not obtained. A viscosity of the white ink is preferably less than 6.0 (mPa·s), and an average particle diameter is preferably 200 (nm) or more.

Further, as shown in Comparative Example 1, when the pre-drying is performed such that the residual amount of the precoating liquid is equal to the residual amount of the precoating liquid of the image containing no white color, it can be seen that the adhesion and opacifying property are good, but the white ink dryness is poor.

In the above-described embodiment, the inkjet head 31W for the white ink is disposed on the upstream side of the inkjet heads for the other color inks in the conveyance direction X. Generally, a soft-packaged printed matter is formed by laminating a plurality of films on a printing base material on which an image is formed. For this reason, a step of laminating the film is included. In this case, it is preferable from the viewpoint of productivity to perform a front printing after the laminating step. In the case of the front printing, the white image is formed in the lowermost layer, so that the inkjet head 31W for the white ink is preferably arranged on the upstream side of the inkjet heads for the other color inks in the conveyance direction X.

Although the embodiments described above show the head units 31 of five colors, the present disclosure is not limited to five colors, but may be more or less than five colors. The head unit 31 is not limited to a line head system. However, the line head system is preferable because the printing speed can be increased. Although a long plastic film (PET film) is used as the printing base material M, a cut film may be used.

Although the present disclosure has been described in particular embodiments, the present disclosure is not limited to the foregoing embodiments. A person skilled in the art may modify the above embodiments so long as they do not deviate from the scope and object of the present disclosure.

1. An inkjet image forming apparatus comprising:
an image forming part which ejects inks of a plurality of colors containing white on a printing base material conveyed in a predetermined conveyance direction, to form an image;
a precoating unit which is arranged on an upstream side of the image forming part in the conveyance direction, and ejects a precoating liquid on the printing base material;
a pre-drying part which is arranged on a downstream side of the precoating unit in the conveyance direction, and pre-dries the precoating liquid ejected on the printing base material before the inks are ejected in the image forming part; and
a control part which controls the pre-drying part to adjust a degree of dryness of the precoating liquid ejected on the printing base material, wherein
the control part controls the pre-drying part so that W1<W2, where W1 (g/m²) is an amount of the pre-coating liquid ejected to the printing base material conveyed to the image forming part when a print job for ejecting the white ink is performed, and W2 (g/m²) is an amount of the pre-coating liquid ejected to the printing base material conveyed to the image forming part when a print job for not ejecting the white ink is performed.

2. The inkjet image forming apparatus according to claim 1, wherein
the image forming part includes a head unit which ejects the ink,
the precoating unit includes a head unit which ejects the precoating liquid, and
both the head units have the same structure.

3. The inkjet image forming apparatus according to claim 2, wherein
the head unit which ejects the white ink is arranged on the upstream side of the head unit which ejects the other color inks.

4. The inkjet image forming apparatus according to claim 1, wherein
a pigment of the white ink is titanium oxide.

5. The inkjet image forming apparatus according to claim 1, wherein
a binder resin of the white ink is polyurethane resin.

6. The inkjet image forming apparatus according to claim 1, wherein
the printing base material is a plastic film.

7. The inkjet image forming apparatus according to claim 1, wherein
when a viscosity of the white ink is set to ρw (mPa·s) and a viscosity of the other color inks is set to ρc (mPa·s), then ρw<ρc.

8. The inkjet image forming apparatus according to claim 1, wherein
when an average particle diameter of the white ink is set to Dw (nm) and an average particle diameter of the other color inks is set to Dc (nm), then Dw>Dc.
